(19) United States
(12) Patent Application Publication
(10) Pub. No.: US 2012/0237855 A1
(43) Pub. Date: Sep. 20, 2012

(54) Fuel Cells with Improved Durability

(75) Inventors: Dennis A. Hucul, Midland, MI (US); Claire Hartmann-Thompson, Midland, MI (US)

(73) Assignee: MICHIGAN MOLECULAR INSTITUTE, Midland, MI (US)

(21) Appl. No.: 13/513,576

(22) PCT Filed: Dec. 8, 2010
(86) PCT No.: PCT/US10/59369

§ 371 Date: Jun. 2, 2012

Related U.S. Application Data
(60) Provisional application No. 61/285,109, filed on Dec. 9, 2009.

(51) Int. Cl. H01M 4/96

(52) U.S. Cl. 429/532

(57) ABSTRACT

A modified carbon-supported metal catalyst is disclosed which has durability and activity wherein the surface of the carbon support has been modified by the addition of silicon carbides or boron carbides made by calcination. This catalyst is used as a catalyzed electrode in fuel cells.

### FEDERALLY SPONSORED RESEARCH STATEMENT

This invention was made with Government support under Award Nos. IIP-0839525 and IIP-1026556 entitled Oxidation Resistant Carbon Supports for Fuel Cells from the

National Science Foundation (NSF) by Oxazogen, Inc. The Government has certain rights to this invention.

### BACKGROUND OF THE INVENTION

1. Field of the Invention

This invention generally relates to improvements in the performance of carbon-supported catalysts in polymer electrolyte fuel cells by surface treatment for improving durability, specifically regarding the carbon cathode of polymer electrolyte fuel cells (PEFCs).

2. Description of Related Art

Fuel cells have the potential to become an important energy conversion technology. In order to reduce dependence on oil and avoid its pollution issues, research efforts on fuel cells have increased in recent years. As a result, much effort has recently been directed towards developing fuel cell systems that are suitable for consumer use over a wide range of applications, from the small (for example, portable 1 kilowatt size generators) to the large (for example, automotive engines or stationary power plants). One of the development objectives relates to lowering costs so that fuel cell systems can be competitive with traditional fossil fuel burning alternatives.

However, one issue that impedes the commercialization of polymer electrolyte fuel cells (PEFCs) is the gradual decline in performance during operation, mainly caused by the loss of electrochemical surface area (ECSA) of carbon-supported platinum nanoparticles at the cathode. Several reasons for the loss of ECSA have been noted: 1) coalescence via migration of platinum (Pt) nanoparticles; 2) particle growth via Ostwald ripening (dissolution and redeposition); 3) detachment of Pt nanoparticles from the carbon support; and 4) dissolution and precipitation in the membrane.

One approach to slow the loss of ECSA of carbon-supported platinum nanoparticles at the cathode is disclosed in U.S. Pat. No. 6,548,202, which attempts to anchor the Pt more strongly to the carbon support. Due to the presence of a variety of different surface groups,

Pt stability on oxide supports is far superior to Pt stability on carbon. One method to enhance the stability on carbon is to add functional groups to the surface that will bind platinum more strongly than carbon alone. This '202 patent employs the use of oxidizing agents to add functional groups to the surface of the carbon supports. This acid treatment generates a number of different surface groups on carbon, such as phenol, carbonyl, carboxyl, quinine, and lactone. Although generation of these surface groups adds potential binding sites for the platinum, the resulting PEFCs have performance that is only marginally better than fuel cells without an acid treatment. In fact this '202 patent discloses almost no improved lifetime with these catalysts. There is an additional disadvantage to this surface oxidation; namely, these surface groups render the carbon more susceptible to further oxidation during operation, which results in faster corrosion of the carbon support and loss of activity.

Another approach is disclosed in U.S. Pat. No. 6,855,453, which attempts to stabilize the carbon support via graphitization. Heating the carbon support to temperatures as high as 3000° C. changes the crystallinity of the carbon and does make the carbon more resistant to oxidation. So far, this approach has given rise to some of the most oxidation resistant fuel cell carbon catalyst supports. However, there is a significant penalty to be paid in terms of surface area as loss of carbon surface area upon high temperature graphitization leads to lower surface area platinum catalysts, and therefore, poorer activity. The loss of surface area upon graphitization makes this a process undesirable for the commercial production of carbon supports for PEFCs.

Clearly it would be advantageous to have a more durable fuel cells as a PEFC, especially durability, slowing corrison and improving performance of the carbon anode and cathode.

### BRIEF SUMMARY OF THE INVENTION

This invention relates to a “modified carbon” metal catalyst support which greatly enhances PEFC durability and maintains the desired activity.

The present invention relates to an electrocatalyst comprising a modified carbon-supported metal catalyst wherein the surface of the modified carbon support comprises surface covalent-carbides. Suitable metals are one or more of platinum (Pt), palladium (Pd), ruthenium (Ru), rhodium (Rh), gold (Au), and silver (Ag). In one embodiment the electrocatalyst contains platinum while the surface of the modified carbon support contains either silicon carbides or boron carbides. The invention also discloses a method of making the electrocatalyst, and the incorporation of the electrocatalyst in the cathode of a polymer electrolyte fuel cell.

Accordingly, the present invention slows deactivation, thereby greatly enhancing PEFC durability.

### BRIEF DESCRIPTION OF THE DRAWINGS

FIG. 1 is a flow chart illustrating a process for making the modified carbon-supported platinum catalyst of this invention.

FIG. 2 is a flow chart illustrating a preferred process of making the catalyzed electrode.

FIG. 3 is a flow chart illustrating a preferred process of making a polymer electrolyte fuel cell.

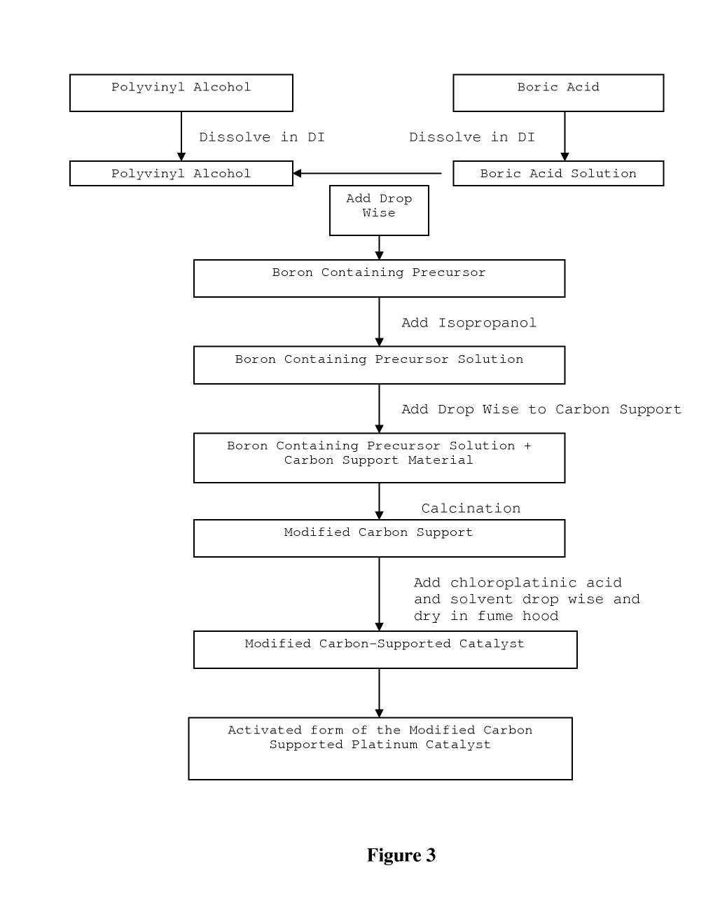

FIG. 4 shows the cell potential as a function of the current density for various MEAs after 30,000 cycles for the results of MEA 3.

### DETAILED DESCRIPTION OF THE INVENTION

### Glossary

The following terms as used in this application are to be defined as stated below and for these terms, the singular includes the plural. cm means centimeters
DMFC means direct methanol fuel cells
DEFC means direct ethanol fuel cells
ECSA means electrochemical surface area
g(s) means gram(s)
GDL means gas diffusion layer(s)
hr(s) means hour(s)
in. means inch(s)
IR means Fourier Transform infrared spectroscopy
MEA means membrane electrode assemblies
min(s) means minute(s)
mL means milliliters
NMR means nuclear magnetic resonance
PEM means proton exchange membrane or poylmer electrolyte membrane
PEFCs means polymer electrolyte fuel cells
Pt means platinum
RT means room temperature, about 20° C. to about 25° C.
sec. means second(s)
SEC means size exclusion chromatography
TGA means thermogravimetric analyses
V means volts or voltage

### General Discussion

The major reasons for the degradation of the cathodic catalyst layer are the dissolution of platinum and the corrosion of carbon under certain operating conditions, especially those of potential cycling. Cycling places various loads on PEFCs, which are usually designed for steady state operations where conditions do not vary. Where conditions vary, in particular, stop-and-go driving, and fuel starvation in vehicular applications these factors can generate high voltage loads that in turn will cause degradation of the PEFCs. Also the coalescence of platinum nanoparticles through migration also results in the loss of surface area.

In use of PEFCs, the particle growth and dissolution of Pt at the cathode is observed. During operation of PEFCs, a gradual decline in performance is found, which is mainly caused by the loss of the ECSA of carbon-supported platinum nanocatalysts at the cathode. Several reasons for the loss of ECSA have been proposed: 1) coalescence via migration of Pt nanoparticles; 2) particle growth via Ostwald ripening (dissolution and redeposition);

3) detachment of Pt nanoparticles from the carbon support; and 4) dissolution and precipitation in the membrane, which in turn enhances the hydrogen peroxide formation and accelerates the membrane degradation.

Also in use of PEFCs, carbon corrosion at the cathode is observed. Such corrosion of carbon support causes detachment and coalescence of Pt nanoparticles, causing a loss of platinum surface area. A general review of these issues is available by Borup et al., Chem. Rev. 107, 3904-3951 (2007).

Various attempts have been tried to provide durability of the cathode in PEM systems, which have resulted in varied degrees of success, but none have been commercially useful to date.

One approach to increase PEFC durability is to inhibit sintering of the platinum during the course of operation. One prior approach is the attempt to anchor platinum more strongly to the carbon support. However, due to the presence of a variety of different surface groups, platinum stability on oxide supports is far superior to platinum stability on carbon [e.g., Palmer, M. et al., J. Chem. Tech. Biotechnol., 30, 205-216 (1980)].

One method to enhance the stability of Pt on carbon is to add functional groups to the surface that will bind the Pt more strongly than Pt on carbon alone. Some work has been reported to partially oxidize the surface of the carbon support so that the improved binding of Pt with an oxide would occur on the carbon surface. Typically such treatment of the carbon involves strong mineral acids such as HNO₃, H₃PO₄, or H₂SO₄. [See Campbell, S. et al., U.S. Pat. No. 6,548, 202.] This acid treatment generates a number of different surface groups on carbon such as phenol, carbonyl, carboxyl, quinone, and lactone. [See Kinoshita, K. in Carbon—Electrochemical and Physicochemical Properties, pp 86-90, pub. John Wiley & Sons, 1988.] Although generation of these surface groups adds potential binding sites for the platinum, the resulting PEM fuel cells have performance that is only marginally better than fuel cells made without an acid treatment. In fact Campbell reported almost no improved lifetime with these catalysts [U.S. Pat. No. 6,548,202]. An additional disadvantage to this surface oxidation occurs because these surface groups render the carbon more susceptible to further oxidation during operation. This results in faster corrosion of the carbon support and loss of activity.

In place of the strong acids, modification of the carbon support was done using chlorination of the carbon to create new Lewis acid sites on the carbon, which sites bind platinum more strongly to the support. Unfortunately, the creation of these sites via chlorination has a major drawback in that the chlorinated carbon is much more susceptible to oxidation. Simple TGA studies, done in our laboratory, show that chlorination of the carbon leads to a support that oxidizes at a temperature 50° C. lower than the untreated support. Clearly, this chlorination (formally termed a partial oxidation of the surface) leads to a catalyst that is less stable.

Other research groups have taken a different approach (e.g., Atanassov, P., et al., “Surface Chemistry and Structure Studies Surface Chemistry and Structure Studies of Carbon Support Corrosion in PEMFC's”, 212th Electrochemical Society Mtg, Washington D.C., October 7-12, 2007). These groups have investigated stabilization of the carbon support via the removal or partial removal of the functional groups on the surface of the carbon support. These surface groups, containing oxygen functionality, serve as potential points of attack for more complete oxidation. Surface groups such as carbonyl and hydroxyl groups can be further oxidized to carboxyl groups and then finally to carbon dioxide. Elimination of these groups can potentially slow the oxidation of the support.

Another approach to stabilization of the carbon support is via graphitization (see, for example, Bett, J. et al., U.S. Pat. No. 6,855,453). Heating the carbon support to temperatures as high as 3000° C. changes the crystallinity of the carbon and does indeed make the carbon more resistant to oxidation. So far, this approach has given rise to some of the most oxidation resistant fuel cell carbon catalyst supports. Unfortunately, there is a significant penalty to be paid in terms of surface area. Loss of the carbon surface area upon high temperature graphitization leads to lower surface area Pt catalysts—and therefore poorer activity. The loss of surface area upon graphitization makes this a process undesirable for the commercial production of carbon supports for PEM fuel cells.

Carbon corrosion is such a significant problem that workers at General Motors have studied the use of sacrificial materials to avoid support oxidation (Zang, J., et al., U.S. Pub. Appln. 2008/0020262, pub. Jan. 24, 2008). In this 2008 patent application, Zhang and coworkers have added a carbon material that oxidizes at a significantly higher rate than the carbon support. The concept is that attack will preferentially occur at the sacrificial carbon rather than at the support carbon thereby extending the catalyst lifetime. It is too early to tell if this is a commercially viable method of slowing down the support corrosion. The support carbon may still corrode at an unacceptable rate, even in the presence of a sacrificial component.

### Present Invention

The present invention takes a different approach by altering the carbon support via the formation of surface carbides that are inherently more resistant to oxidation [see Fergus, J., et al., Carbon, 33(4), 537-543 (1995)]. To maintain the properties such as conductivity only the covalent carbides—chiefly boron carbide and silicon carbide—are used. Although simple binary carbides are used in this invention, some ternary systems are also believed useful.

To accomplish this task, carbons must be produced under mild enough conditions that the support surface area is not decreased. If the synthesis conditions require calcination reactions at temperatures that are too high, above 1000° C., then loss of support surface area happens and defeats the objective. Silicon carbide has been shown to be an effective material for enhancing the oxidation resistance of carbon [e.g., Moene, R., et al., Carbon, 34(5), 567-579 (1996)], but until recently, the synthesis methods used required high temperatures. Moene and coworkers demonstrated that a CH₄/SiCl₄ mixture could produce an effective oxidation resistant carbon after calcination at 1102° C. They could decrease the calcination temperature to 927° C. by using CH₃SiCl₃ as the precursor. Unfortunately, these conditions are too severe for fuel cell carbons.

Recently a new manufacturer has started to supply silicon carbide precursors that decompose at relatively low temperatures—as low as 400° C. (i.e., Starfire Systems Inc., 10 Hermes Road, Malta, N.Y.). These materials, specifically allylhydridopolycarbosilane, dimethoxypolycarbosilane and hyperbranched polycarbosilane, are low volatility precursors that have a high yield to silicon carbide after calcinations at temperatures below 950° C., preferably in the 400-850° C. temperature range. Although originally produced for coating applications in the electronics industry, these materials are promising candidates for formation of low temperature silicon carbide materials. In terms of temperature, they represent a step change in technology.

Similar observations can be made for boron modified coatings. Although it has been shown that boron addition to carbon can enhance its oxidation resistance, generally temperatures in excess of 1200° C. are required [see Fergus, J., et al., Carbon, 33(4), 537-543 (1995)]. Precursors such as the polymer formed by the reaction of boric acid and polyvinyl alcohol provide a source of new material for the formation of boron carbide. Mondal and Banthia have recently shown that calcination of this polymer at temperatures in the region 400-800° C. produces pure boron carbide [see Mondal, S. and Banthia, A., J. Eur. Ceramic Soc., 25(2-3), 287-291 (2005)]. They have touted this as a unique low-temperature (400° C.) synthetic route for boron carbide.

There is another potential benefit to using modified carbons as a new support as some precedent in the literature for better anchoring of Pt particles to a carbon support via modification has been noted. Turner and coworkers have recently published the results of modeling studies on the stabilization of small Pt clusters by boron doped carbon clusters [e.g., Acharya, C. and Turner, C., J. Phys. Chem. B, 110, 17706-17710 (2006)]. Their modeling work clearly indicates that “the presence of substitutional boron defects in carbon supports increases the adsorption energy of the metal atoms” (like Pt). This will lead to enhanced stabilization of Pt based catalysts during operation in a fuel cell. In addition, the amount of boron added to the carbon to achieve this stabilization is relatively small, in the region of 5 to 10 percent by weight. Because the amount of boron can be small the high electrical conductivity of the carbon should be maintained.

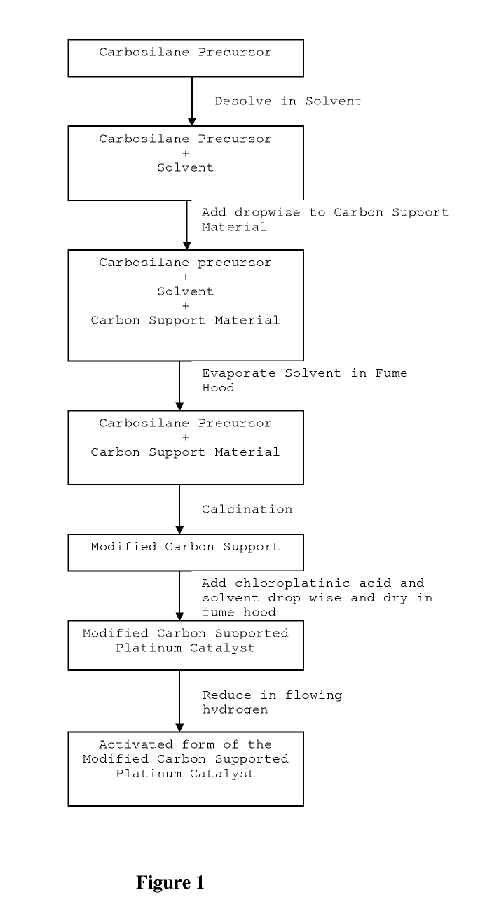

In the present invention, carbon support material intended for use in a carbon supported platinum catalyst is modified to form surface carbides, namely surface covalent carbides, in order to slow carbon corrosion by providing a protective layer that is resistant to oxidation, and increase bond strength between the carbon support and the platinum. The production of the modified carbon-supported platinum catalyst was performed by initially modifying the carbon support material to form surface covalent carbides. This is achieved by dissolving a carbosilane precursor (allylhdridopolycarbosilane) in a solvent to form a carbide precursor containing solution. Then, the carbosilane precursor containing solution is added dropwise to a carbon support material. The surface covalent carbides are then formed by calcining the carbosilane precursor containing solution and carbon support material, using the standard calcination process described below, to form a modified carbon support containing carbide covalent bonds. This is illustrated by the flow chart of FIG. 1.

This process may also be accomplished to form boron carbide covalent bonds on the modified carbon support. This process was performed by making a master solution formed by dissolving 1.51 g of polyvinyl alcohol in 21 mL of deionized water and heating to 80° C. with constant stirring. A second solution was made by dissolving 0.71 g of boric acid in 14 mL of deionized water. This second solution was also heated to 80° C. With constant stirring, this boric acid solution was added dropwise to the polyvinyl alcohol solution, forming a boron containing precursor. Isopropanol was then added to the boron containing precursor, which is then mixed thoroughly. This boron containing precursor solution is then added dropwise to the carbon support material. The surface covalent carbides are then formed by calcining the boron containing precursor solution and carbon support material, using the standard calcination process described below, to form a modified carbon support containing carbide covalent bonds.

The modified carbon support material is then combined with platinum (Pt) and reduced to form the activated modified carbon-supported platinum catalyst. Although Pt is preferred, a modified carbon-supported metal catalyst where the modified carbon-supported catalyst comprises one or more of the following metals is included: platinum (Pt), palladium (Pd), ruthenium (Ru), rhodium (Rh), gold (Au), and silver (Ag). This carbon-supported catalyst may also have a mixed metal component that includes cobalt (Co), nickel (Ni), iron (Fe), or chromium (Cr).

Platinum addition is accomplished by adding chloroplatinic acid in ethanol solution dropwise to the modified carbon support to form modified carbon supported catalyst. Next, the modified carbon supported platinum catalyst is dried in a fume hood. Finally, the modified carbon-supported platinum catalyst is reduced using known reducing agents such as gaseous reducing agents like hydrogen, ammonia, or carbon monoxide or liquid reducing agents such as hydrazine or others, or organics like formaldehyde, or a similar reducing agent, to form the activated modified carbon-supported platinum catalyst. See flow chart for FIG. 1.

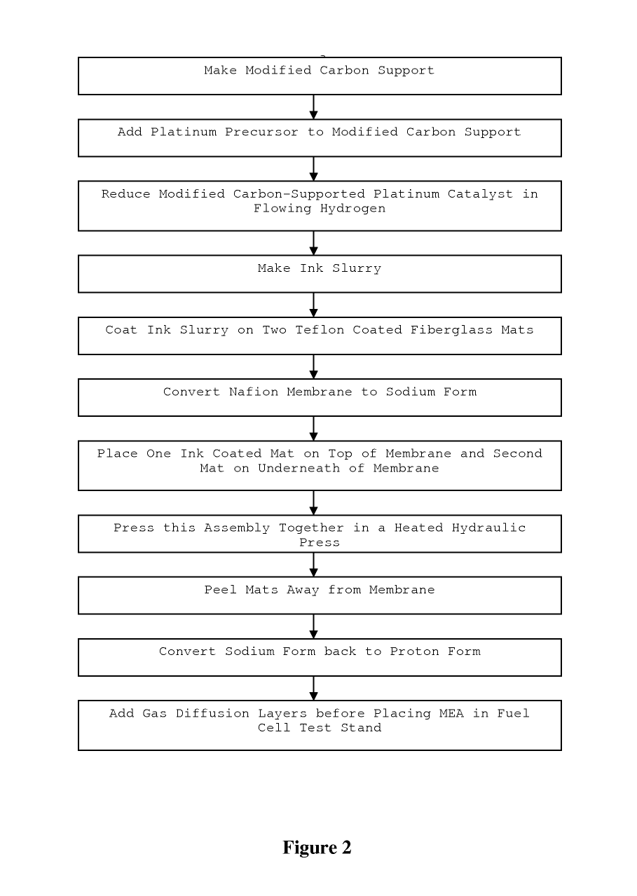

For this invention a number of precursors were added to a carbon cathode to obstensively create a protective layer of either silicon carbide or boron carbide. In general two classes of modifying precursors were used. One involved using a carbosilane precursor and the second involved a boric acid—polyvinyl alcohol polymer precursor. Of those two materials the carbosilane precursors gave the best results to date. A variety of different carbosilane precursors such as hydridopolycarbosilane, dimethoxypolycarbosilane, and 2,4,6-trimethyl-2,4,6-trisilaheptane were tried, but allylhydridopolycarbosilane was chosen because under the preparation conditions it gave the best coating yields. For the boron modified materials only the boric acid—polyvinyl alcohol polymer precursor was studied. The invention also discloses the use of the above described modified carbon-supported platinum catalyst to form a catalyzed electrode for the use in a polymer electrolyte fuel cell (PEFC). The production of this fuel cell was preformed by first making “ink slurry,” which consists of propylene carbonate, isopropanol, a solution of Nafion™ (DuPont) ionomer, and the modified carbon-supported platinum catalyst. After mixing thoroughly, the slurry was then added evenly to a central masked off section of two square pieces of Teflon™ (DuPont) coated mats. The solvents were then allowed to evaporate from the mats. A second identical coat was then applied. After drying, these mats were ready to be made into membrane electrode assemblies (MEAs). See the flow chart for FIG. 2.

While not wishing to be bound by theory, it is believed that the present invention slows deactivation by at least two major mechanisms. First, it dramatically slows carbon corrosion by providing a protective layer that is resistant to oxidation and second, the modified carbon increases the bond strength between Pt and the support—slowing particle growth and dissolution. Although all of the present testing was done with fuel cells that use hydrogen and oxygen as the feedstocks, it is believed that this invention will work well with direct methanol fuel cells (DMFC), phosphoric acid fuel cells (PAFC) or direct ethanol fuel cells (DEFC).

The invention will be further clarified by a consideration of the following examples, which are intended to be purely exemplary of the present invention.

### Materials

Carbon black or carbon was Vulcan XC-72, which was dried where indicated. All reagents were used as received from commercial sources unless otherwise stated.

### Methods

### Standard Calcination Procedure for Modified Carbons:

The uncalcined portion of the carbon (resting on a plug of quartz wool) was placed in the center of a 1.0 in. O.D. quartz tube. The tube containing the carbon was placed in a vertical tube furnace and then was purged with nitrogen for about 5 mins at about 100 cc/min The gas flow was then decreased to about 10 cc/min of nitrogen and the furnace was programmed to heat the catalyst bed from RT to 850° C. at 10° C./min After reaching 850° C., the catalyst bed was maintained at that temperature for 2 hrs before cooling back to RT and removing the sample.

### Nafion™ Membrane Preparation

A Nafion™ membrane is converted to the sodium form, by placing it in a solution of sodium chloride and heated to about 65° C. and held at that temperature for 1 hr. The membrane is then removed from the solution and dried Immediately before use, this membrane was placed in a holder and then into a vacuum oven at 70° C. and held there for 1 hr. The ink coated mats are then placed on both sides of the membrane and pressed together, and heated to 210° C. The assembly was then cooled to RT. Before use, the assembly was placed in an acid bath to convert it from the sodium form back to the proton form. Finally, gas diffusion layers were added to the assembly before placing the MEA in a fuel cell test stand.

Preparation of Modified Carbons from a Carbosiane Precursor

### EXAMPLE 1

Preparation of Modified Carbons from Allylhydriodopolycarbosilane

Allylhydridopolycarbosilane (0.0011 g) was dissolved in 2.8 g of toluene to make a solution. This solution was the added dropwise to 1.0 g of dried carbon black. The solvent was allowed to evaporate in a fume hood for about 3 hrs and then the sample was calcined under standard conditions above to form a modified carbon.

### EXAMPLE 2

Preparation of Modified Carbons from Allylhydriodopolycarbosilane

Allylhydridopolycarbosilane (0.055 g; Starfire Systems SMP-10) was dissolved in 14.0 g of toluene to form a solution. This solution was then added dropwise to 5.0 g of dried carbon black. The solvent was allowed to evaporate in a fume hood for about 3 hrs and then the sample was calcined under standard conditions above to form a modified carbon.

### EXAMPLE 3

Preparation of Modified Carbons from Allylhydriodopolycarbosilane

A solution was made by dissolving 0.137 g of allylhydridopolycarbosilane in 14.0 g of toluene. This solution was the added dropwise to 5.0 g of dried carbon black. The solvent was allowed to evaporate in a fume hood for about 3 hrs and then the sample was calcined under standard conditions above to form a modified carbon.

### EXAMPLE 4

Preparation of Modified Carbons from Allylhydriodopolycarbosilane

A solution was made by dissolving 0.236 g of allylhydridopolycarbosilane in 12.0 g of toluene. This solution was the added dropwise to 4.4 g of dried carbon black. The solvent was allowed to evaporate in a fume hood for about 3 hrs and then the sample was calcined under standard conditions above to form a modified carbon.

Spectroscopic analysis for Examples 1-4 by an independent lab gave the following % Si after calcination as shown in Table 1:

TABLE 1

| Example | % of Precursor | % Si |
|---|---|---|
| 1 | 0.11 | est 0.05 |
| 2 | 1.1 | 0.54 |
| 3 | 2.6 | 1.08 |
| 4 | 5.1 | 2.02 |

These results show the amount of Si incorporated in the carbon support.

### EXAPMLE 5

Preparation of a Hyperbranched Polycarbosilane by Reaction of Tetraallylsilane with 1,1,4,4-Tetramethyl-1,4-Disilabutane

A 100 mL round-bottomed flask was charged with tetraallylsilane (6.19 g, 32.19 mmol, 3 equivalents allyl), 1,1,4,4-tetramethyl-1,4-disilabutane HSiMe₂CH₂CH₂SiMe₂H (3.14 g, 21.46 mmol, 1 equivalent SiH), anhydrous tetrahydrofuran (THF, 20 mL), and 1 drop of platinum divinyltetramethyldisiloxane complex in xylene (Karstedt's catalyst, 2.1-2.4% platinum). The mixture was refluxed for 16 hrs, and anhydrous monomer and excess THF were removed in vacuo. The residue was washed with acetonitrile (5×20 mL) and dried under vacuum for 16 hrs to give a quantitative yield of hyperbranched polycarbosilane as a yellow oil (1.71 g). Characterization of the isolated reaction product gave the following spectra:
IR (KBr disc): ν (cm-1) 3076 (allyl);
¹H NMR (CDCl₃): δ (ppm) ( ) (s; SiCH₃), 0.41 (s; SiCH₂CH₂Si), 0.60-0.73 (m; SiCH₂CH₂CH₂), 1.36-1.45 (m; SiCH₂CH₂CH₂), 1.57-1.66 (m; SiCH₂CH═CH₂), 4.86-4.92 (m; CH═CH₂), 5.78-5.89 (m; CH═CH₂);
²⁹Si NMR (CDCl₃): −3.6 (Si(CH₂)₃CH₂CH═CH₂), ( ) (Si(CH₂)₄); and
SEC (THF): Mw=9085, Mn=2710, polydispersity=3.35.

### EXAMPLE 6

### Preparation of a Modified Carbon From a Hyperbranched Polycarbosilane.

A solution was made by dissolving 0.137 g of a hyperbranched polycarbosilane in 14.0 g of toluene. This solution was the added dropwise to 5.0 g of dried carbon black. The solvent was allowed to evaporate in a fume hood for about 3 hrs and then the sample was calcined under standard conditions above to form a modified carbon.

Preparation of Modified Carbons from a Boron Containing Precursor

### EXAMPLE 7

### Preparation of Master Solution I

A Master Solution I was made by dissolving 1.51 g of polyvinyl alcohol (Sigma-Aldrich) in 31 mL of deionized water and heating to 80° C. with constant stirring. A second solution was made by dissolving 0.71 g of boric acid (Acros Organics) in 14 mL of deionized water. This second solution was also heated to 80° C. With constant stirring this boric acid solution was added dropwise to the polyvinyl alcohol solution. This Master Solution I was then slowly cooled with constant stiffing.

### EXAMPLE 8

### Preparation of Modified Carbon 6

A 3.45 g portion of isopropanol was added to 2.55 g portion of the Master Solution I. After mixing thoroughly, this solution was added to 2.0 g of dried carbon. The solvents were allowed to evaporate overnight in a fume hood and then the modified carbon was calcined under the standard procedure above. This material is now referenced as Modified Carbon 6.

### EXAMPLE 9

### Preparation of Modified Carbon 7

A 0.60 g portion of isopropanol was added to 5.1 g portion of the Master Solution I. After mixing thoroughly, this solution was added to 2.0 g of dried carbon. The solvents were allowed to evaporate overnight in a fume hood and then the modified carbon was calcined under the standard procedure above. This material is now referenced as Modified Carbon 7.

### EXAMPLE 10

### Preparation of Modified Carbon 8

A 0.60 g portion of isopropanol was added to 5.1 g portion of the Master Solution I. After mixing thoroughly, this solution was added to 2.0 g of dried carbon. The solvents were allowed to evaporate overnight in a fume hood and then the modified carbon was calcined under the standard procedure above. A second addition was then made to the carbon using a 0.60 g portion of isopropanol and a 5.1 g portion of the Master Solution I. The solvents were allowed to evaporate overnight in a fume hood and then the modified carbon was calcined a second time under the standard procedure above. This material is now referenced as Modified Carbon 8.

### EXAMPLE 11

### Preparation of Master Solution II

A second Master Solution II was made by dissolving 3.0 g of polyvinyl alcohol (Sigma-Aldrich) in 50 mL of deionized water and heating to 80° C. with constant stiffing. A second solution was made by dissolving 1.4 g of boric acid (Acros Organics) in 20 mL of deionized water. This second solution was also heated to 80° C. With constant stirring this boric acid solution was added dropwise to the polyvinyl alcohol solution. This second Master Solution II was then slowly cooled with constant stirring.

### EXAMPLE 12

### Preparation of Modified Carbon 9

A 2.0 g portion of isopropanol was added to 15.0 g portion of the Master Solution II. After mixing thoroughly, this solution was added to 5.0 g of dried carbon. The solvents were allowed to evaporate overnight in a fume hood and then the modified carbon was calcined under the standard procedure above. This procedure was repeated 3 more times to give a total of 4 additions of material to the carbon. After the final calcination this material is now referenced as Modified Carbon 9.

Preparation of Modified Carbons Activated with Pt

### EXAMPLE 13

### General Method of Pt Addition to Modified Carbon

Platinum (Pt) was then added to these modified carbons and they were activated by reduction in flowing hydrogen. In all tests, platinum was added to give a final loading of about 20% Pt/C after activation. This procedure prepared the catalyst for each modified carbon.

For modified carbons 1, 2, 3 and 5 the following procedure was used:

A solution was made containing 0.66 g of H₂PtCl₆·6H₂O (Acros Chemical) dissolved in 2.8 g of ethanol. This solution was then added dropwise to 1.0 g of a modified carbon. After drying overnight in a fume hood, the catalyst was placed in the center of a 1.0 in. O.D. pyrex glass tube with the catalyst resting on a plug of glass wool. The catalyst was then reduced in flowing hydrogen. This process starts by purging the tube containing the catalyst with nitrogen for about 5 min at about 100 cc/min The gas composition was then changed to 90% hydrogen+10% nitrogen at approximately 60 cc/min and the furnace was programmed to heat the catalyst bed from RT to 250° C. at 10° C./min. After reaching 250° C., the catalyst bed was maintained at that temperature for 2 hrs before cooling back to RT. This is now the activated (reduced) form of the catalyst; now Catalyst 1, 2 and 3.

The procedure for modified carbon 4 was similar except that 0.33 g of H₂PtCl₆·6H₂O (Acros Chemical) was dissolved in 1.4 g of ethanol. This solution was then added dropwise to 0.5 g of modified carbon 4; now Catalyst 4.

The procedure used for adding platinum to modified carbon 4 was also used for all of the boron modified carbons (6, 7, 8 and 9); forming Catalyst 6, 7, 8 and 9.

### EXAMPLE 14

### Preparation of a Standard Catalyst (Std)

A solution was made containing 1.57 g of H₂PtCl₆·6H₂O (Acros Chemical) dissolved in 7.7 g of ethanol. This solution was then added dropwise to 2.45 g of a dried carbon. The activation procedure was identical to that used for the platinum on modified carbon catalysts.

### EXAMPLE 15

### MEA Preparation

MEAs for testing were made via a “decal transfer” method (e.g., Hoogers, Gregor ed., Fuel Cell Technology Handbook, CRC Press, Boca Raton, pp 4-18, 2003), but any method of making a functioning fuel cell is acceptable. For example, the catalyst in appropriate slurry can be sprayed directly on a membrane or the catalyst can be added to a gas dispersion layer and then this layer can be pressed against each side of the membrane.

A. The general procedure used for preparing transfer decals from a catalyst “ink” is as follows:

A square piece of teflon coated fiberglass mat (3.0 in. on each side) was masked off so the center 1.0 in.² portion is readied. This process was repeated on a second mat. A slurry was made from 0.15 g of propylene carbonate, 0.05 g of isopropanol, 0.03 g of a 10% solution of Nafion™ ionomer, and 0.011 g of a reduced 20% Pt/C catalyst. After mixing thoroughly, this slurry was then added evenly to the central masked off section of the two mats. The solvents were then allowed to evaporate from the mats. A second identical coat was then applied. After drying these decals were ready to be made into an MEA.

B. Procedure for conversion of a nafion membrane to the sodium form:

A square piece of nafion (1035), 3.0 in. on each side, was placed in a bath containing a 1.0 molar solution of sodium chloride. This bath containing the membrane was then heated to about 65° C. and held at that temperature for 1 hr. The membrane was then removed from the solution and dried Immediately before use, this membrane was placed in a holder and then into a vacuum oven at 70° C. and held there for 1 hr. This vacuum dried membrane was ready to be made into an MEA.

C. Preparation of the MEA

A piece of vacuum dried nafion 1035 was used as the membrane and then one ink coated mat is placed on top of the membrane with its ink side down and a second mat was placed underneath the first membrane with its ink side up. This assembly was then placed between two Viton™ press pads. This entire assembly was then placed between two metal plates and then into a hydraulic press that had been previously heated to about 210° C. Pressure was applied until the gauge reads 2000 psi and then these conditions are maintained for 15 min. The assembly was cooled to about RT while maintaining constant pressure. After releasing the pressure, the assembly was removed from the press and the mats were carefully peeled away from the membrane.

Before use the assembly was placed in an acid bath to convert it from the sodium form back to the proton form by placing the MEA in a 0.5 molar bath of sulfuric acid. The bath containing the MEA was heated to 80° C. and held at that temperature for 1 hr. The

MEA was rinsed with deionized water and then placed in a deionized water bath. The bath was then heated to 80° C. and held for 1 hr. The MEA was removed from the bath and dried. The MEA was now ready for the addition of gas diffusion layers to each side before being tested in a test stand manufactured by Fuel Cell Technologies, Inc.

The MEA 1 was made with Catalyst 1 and started with Modified Carbon 1. Likewise MEA 2 was made with Catalyst 2 and started with Modified Carbon 2; and similarity continued up to MEA 9.

Thus the MEA process used for testing can be described generally as follows:
1. Dry carbon or make Modified Carbon
2. Add Pt precursor to Modified Carbon or carbon
3. Reduce Pt/C to metal in flowing hydrogen
4. Make “ink” slurry (solvents plus catalyst plus ionomer)
5. Coat ink on two teflon coated fiberglass mats
6. Convert nafion membrane to sodium form
7. Place one ink coated mat on top of membrane (ink side down) and second mat on underneath membrane (ink side up)
8. Press this assembly together in a heated hydraulic press
9. Peel mats away from membrane (catalyst now sticks to both front and back of membrane)
10. Convert sodium form back to proton form
11. Add gas diffusion layers (GDL) before placing MEA in fuel cell test stand
   This finished fuel cell would be considered a five layer MEA (GDL-Catalyst-Membrane-Catalyst-GDL).

### EXAMPLE 16

### MEA Testing

There are two important properties of the MEAs—initial activity and long term durability. For a number of the catalysts tested, the initial activity was lower than desired so no long term studies for durability were done. To test the durability of the MEAs an accelerated stress test was done using the metrics in Table 2 below.

TABLE 2

| Parameter | Conditions |
|---|---|
| Cycle | Step change: 30 sec. at 0.7 V |
| | and then 30 sec. at 0.9 V |
| Number | 30,000 cycles |
| Cycle time | 60 sec. |
| Temperature | 70° C. |
| Relative Humidity | 80% |
| Fuel/Oxidant | Hydrogen/Oxygen |
| Pressure | Cell pressure varies but |
| | generally about 110 kPa |
| | absolute |
| Polarization Curve | After 0, 1k, 5k, 10k, 15k, 20k, |
| | 25k, 30k cycles |

The MEAs were subjected to a large number of voltage changes switching back and forth from a high voltage to a lower voltage every 30 sec. After every 5,000 cycles the cycling was paused and an activity measurement was made by generating a polarization curve. Activity loss versus time was measured by noting the voltage change at a constant current density of 0.80 amps/cm². The activity after a given number of cycles could thus easily be compared to the early activity of an MEA. The results are given in Table 3 below.

TABLE 3

| MEA | Modifier | Activity Loss* |
|---|---|---|
| 1 | Si | initial activity lower |
| 2 | Si | 17% after 5,000 cycles |
| 3 | Si | 0% after 30,000 cycles |
| 4 | Si | 0% after 30,000 cycles |
| 5 | Si | 0% after 30,000 cycles |
| 6 | B | initial activity lower |
| 7 | B | initial activity lower |
| 8 | B | initial activity lower |
| 9 | B | 11% after 30,000 cycles |
| 10 | Std | 44% after 5,000 cycles |

*Change in voltage with time at a constant current of 0.80 Amps/cm².

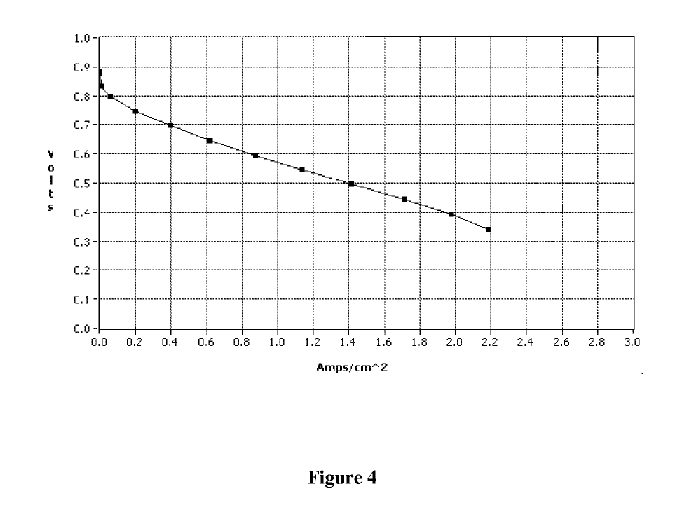

FIG. 4 shows the polarization curve for MEA 3 after 30,000 cycles.

It is evident that the catalysts prepared by the addition of these modifiers can have a strong effect on the lifetime of an MEA. In particular some catalysts made with carbosilane precursors can dramatically improve the lifetime and stability of an MEA.

Although the invention has been described with reference to its preferred embodiments, those of ordinary skill in the art may, upon reading and understanding this disclosure, appreciate changes and modifications which may be made which do not depart from the scope and spirit of the invention as described above or claimed hereafter.

1. A modified carbon-supported metal catalyst wherein the surface of the modified carbon support comprises surface covalent-carbides.

2. The modified carbon-supported metal catalyst of claim 1 wherein the surface covalent-carbides comprise silicon carbides.

3. The modified carbon-supported metal catalyst of claim 1 wherein the surface covalent-carbides comprise boron carbides.

4. The modified carbon-supported metal catalyst of claim 1, wherein the metal comprises one or more of platinum (Pt), palladium (Pd), ruthenium (Ru), rhodium (Rh), gold (Au), and silver (Ag).

5. The modified carbon-supported metal catalyst of claim 4, wherein the metal is platinum (Pt).

6. The modified carbon-supported metal catalyst of claim 4, wherein a mixed catalyst is used that also comprises cobalt (Co), nickel (Ni), iron (Fe), or chromium (Cr).

7. A process of preparing the modified carbon-supported Pt catalyst of claim 1 comprising the steps of:
a. Dissolving carbide precursor in a solvent to form a carbide precursor containing solution;
b. Adding carbide precursor containing solution dropwise, at a temperature below 1,000° C., to carbon support material;
c. Calcining a carbide precursor containing solution and carbon support material to form a modified carbon support;
d. Adding chloroplatinic acid and ethanol solution dropwise to modified carbon support to form modified carbon supported catalyst;
e. Drying modified carbon supported platinum catalyst; and
f. Reducing modified carbon-supported platinum catalyst using a reducing agent to form the activated modified carbon-supported platinum catalyst.

8. The process according to claim 7 where said carbide precursor decomposes to form silicon carbide at temperatures below 950° C.

9. The process according to claim 8 where said carbide precursor is allylhdridopolycarbosilane or hyperbranched polycarbosilane.

10. The process according to claim 7 where said carbon support material is carbon black.

11. A catalyzed electrode comprising the modified carbon-supported metal catalyst of claim 1.

12. A polymer electrolyte fuel cell comprising a catalyzed electrode as claimed in claim 11.
